(19) United States
(12) Patent Application Publication
(10) Pub. No.: US 2012/0229808 A1
(43) Pub. Date: Sep. 13, 2012

(54) BIOCHIP IDENTIFICATION APPARATUS, BIOCHIP AND METHOD OF IDENTIFYING BIOCHIP USING THE SAME

(75) Inventors: Dae-Sik LEE, Daejeon (KR); Byounggoo Jeon, Daejeon (KR)

(73) Assignee: Electronics and Telecommunications Research Institute, Daejeon (KR)

(21) Appl. No.: 13/368,277

(22) Filed: Feb. 7, 2012

(30) Foreign Application Priority Data
Mar. 11, 2011 (KR) 10-2011-0022052
Nov. 24, 2011 (KR) 10-2011-0123606

(51) Int. Cl. G01J 3/46; G01N 21/59

(52) U.S. Cl. 356/402; 356/432

(57) ABSTRACT

A biochip identification apparatus is provided. The biochip identification apparatus may include a light emitting part irradiating a light to a light transfer channel having at least one hole penetrating a body of biochip, a light receiving part receiving a light pattern formed after the light passed through the light transfer channel and converting it into an electrical signal, and a loading part into which the biochip is inserted. The biochip is identified by a shape of the light pattern.

### CROSS-REFERENCE TO RELATED APPLICATIONS

This U.S. non-provisional patent application claims priority under 35 U.S.C. §119 of Korean Patent Applications No. 10-2011-0022052 and No. 10-2011-0123606, filed on Mar. 11, 2011 and Nov. 24, 2011, the entire contents of which are hereby incorporated by reference.

### BACKGROUND

The present inventive concept herein relates to biochip identification apparatus for analyzing biological sample, biochips and methods of identifying biochip chip using the same, and more particularly, to an optical biochip identification apparatus that can obtain the type of biochip and measurement information, a biochip and a method of identifying biochip chip using the same.

A diagnostic strip or a biochip using a biological sample such as urine, blood, saliva, etc. is applied to various individual test items. That is, this is applied to a diagnosis of pregnancy, ovulation, prostate cancer, colorectal cancer, myocardial infarction, Helicobacter pylori, AIDS, drugs, etc. These sensing biomarkers may be HCG, PSA, AFP, CEA, etc.

A disease test by a rapid test paper method is a semiquantitative test selectively checking all kinds of diseases in a body primarily and is well known as a method that can check a body disorder in early stage. If using the rapid test paper method, it is easy to take urine, blood, saliva, etc., a test load is not imposed on an examinee and a response to the result can be judged immediately. Thus, its usability is very high. A rapid strip using the rapid test paper method marks a test result so that a user can check whether or not a body has a problem on corresponding test items with the naked eye. A user can easily use the rapid strip without separate auxiliary equipment. However, the rapid strip has disadvantages that due to a strip characteristic using a test part per test item attached to nitrocellulose test paper, there is a sensing range for being difficult to distinguish a color band represented by a sensing result with naked eye and the accuracy is low because a distinguishment is different depending on an individual emotional state. Also, since the rapid strip has no method that can store patterns to utilize a test result, there are a lot of obstacles to utilize measurement data. Reading apparatus being sold in the market is big apparatus that can be used in a hospital and is very expensive. Portable disease reading apparatus that can be easily used in a home has not been reported yet. To reading the various disease biomarkers described above using the portable disease reading apparatus, identifying each strip has to be preceded before the reading.

In a conventional technology for identifying the type of strip or the type of biochip, an identification information recording means is attached to a strip or biochip, and then all sorts of information about the type and manufacture of the strip or biochip is identified by analyzing the identification information recorded on the attached identification information recording means. That technology may include recording all sorts of information of bio sensor using a bar code and reading the bar code using bar code identifying apparatus for identifying the bar code to identify the information of the bio sensor. In the case of using the bar code as an identification information recording means of the bio sensor, there are disadvantages that an additional cost may occur in making a bio sensor and expensive equipment such as a scanner for identifying the bar code is needed.

As another example, there is a technology that different light-scattering portions are separately included in a diagnostic strip, when connecting the diagnostic strip to the measurement equipment, a light-scattering index is automatically measured and information about diagnostic strip is automatically recognized. In this technology, there are also disadvantages that an additional light-scattering portion has to be attached after manufacturing the diagnostic strip and an additional light receiving part has be further included besides a light receiving part receiving a reflected light for sensing a scattered light.

Thus, a new equipment and a new method that can record various identification information of the type of strip or biochip and manufacturing company of the strip or the biochip in the process of manufacturing the strip or the biochip at low cost and simply and easily identify them are urgently needed. The new equipment and the new method are advantageous in price competitiveness.

### SUMMARY

Embodiments of the inventive concept provide a biochip identification apparatus. The biochip identification apparatus may include a light emitting part irradiating a light to a light transfer channel having at least one hole penetrating a body of biochip; a light receiving part receiving a light pattern formed after the light passed through the light transfer channel and converting it into an electrical signal; and a loading part into which the biochip is inserted. The biochip is identified by a shape of the light pattern.

Embodiments of the inventive concept also provide a biochip identification apparatus. The biochip identification apparatus may include a light emitting part irradiating a light to a light transfer channel including a hole penetrating a body of biochip and a translucent film covering the hole; a light receiving part receiving a light that passed through the light transfer channel and then converting it into an electrical signal; and a loading part to which the biochip is inserted. The biochip is identified by recognizing a difference of strength or color of the light by the translucent film.

Embodiments of the inventive concept also provide a biochip. The biochip may include a body; a biological sample inlet disposed on the body; a sensing part sensing the biological sample transferred from the biological sample inlet; and a light transfer channel having at least one hole penetrating the body and through which a light passes.

Embodiments of the inventive concept also provide a method of identifying a biochip. The method may include loading a biochip including a body and a light transfer channel having at least one hole penetrating the body by inserting them into a biochip identification apparatus; irradiating a light to the light transfer channel; receiving a light that passed through the light transfer channel and converting it into an electrical signal; and identifying the biochip by the light.

### BRIEF DESCRIPTION OF THE FIGURES

Preferred embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout.

FIGS. 1A and 1B are a schematic view and a cross sectional view for describing a biochip identification system, in accordance with some embodiments of the inventive concept.

FIG. 2 is a block diagram for describing a biochip identification apparatus in accordance with some embodiments of the inventive concept

FIGS. 3A, 3B and 3C are a perspective view, a cross sectional view and a top plan view for describing a portion of biochip identification system in accordance with some embodiments of the inventive concept.

FIG. 4 is a perspective view for describing a portion of biochip identification system in accordance with some other embodiments of the inventive concept.

FIGS. 5 and 6 are a perspective view and a schematic view for describing a portion of biochip identification system in accordance with some other embodiments of the inventive concept.

FIGS. 7A and 7B are a perspective view and a cross sectional view for describing a portion of biochip identification system in accordance with some other embodiments of the inventive concept

FIGS. 8A and 8B are perspective views for describing a portion of biochip identification system in accordance with some other embodiments of the inventive concept.

### DETAILED DESCRIPTION OF THE EMBODIMENTS

Embodiments of inventive concepts will be described more fully hereinafter with reference to the accompanying drawings, in which embodiments of the invention are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions; integers, steps, operations, elements, components, and/or groups thereof It will also be understood that when an element such as a layer, region or substrate is referred to as being “on” or “onto” another element, it may lie directly on the other element or intervening elements or layers may also be present.

Embodiments of the inventive concept may be described with reference to cross-sectional illustrations, which are schematic illustrations of idealized embodiments of the present invention. As such, variations from the shapes of the illustrations, as a result, for example, of manufacturing techniques and/or tolerances, are to be expected. Thus, embodiments of the present invention should not be construed as limited to the particular shapes of regions illustrated herein, but are to include deviations in shapes that result from, e.g., manufacturing. For example, a region illustrated as a rectangle may have rounded or curved features. Thus, the regions illustrated in the figures are schematic in nature and are not intended to limit the scope of the present invention.

Technical features of the inventive concept are described with an illustration of biochip identification system using a biochip. However, the technical features of the inventive concept are not limited to the biochip identification system using a biochip and may be applied to identification systems using a strip. Also, a structure of biochip identification apparatus for attaching or detaching a biochip is only one example.

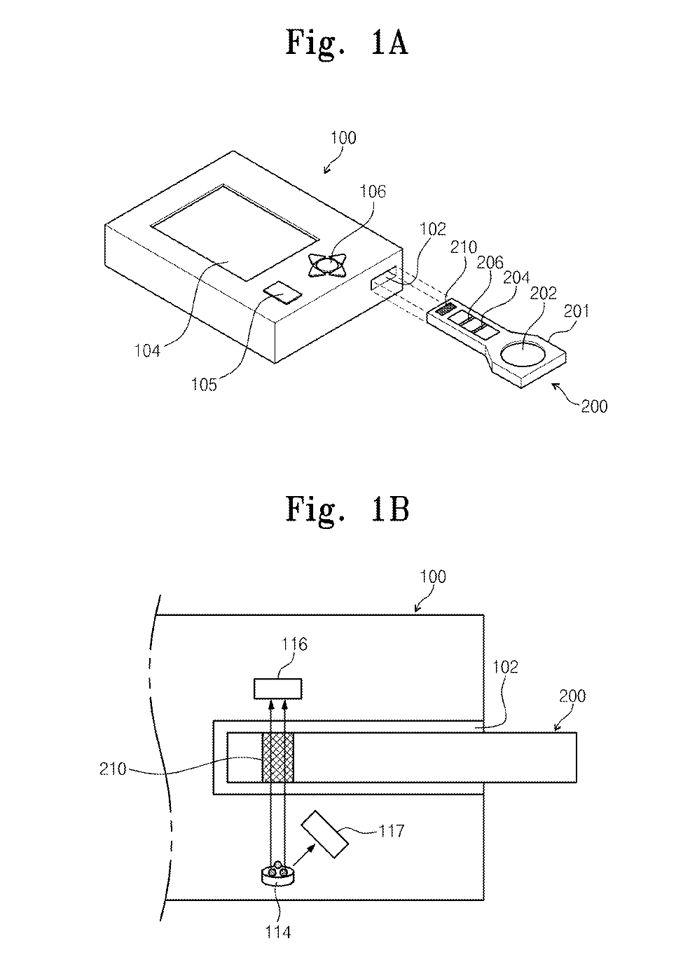

FIGS. 1A and 1B are a schematic view and a cross sectional view for describing a biochip identification system in accordance with some embodiments of the inventive concept.

Referring to FIGS. 1A and 1B, a biochip identification system may include a biochip 200 and a biochip identification apparatus 100 identifying information of the biochip 200.

The biochip 200 may include a biological sample inlet 202, a sensing part 204, a reference part 206 and a biochip identification part 210. The biochip identification part 210 may be a means for identifying the type of the biochip 200. The biochip identification part 210 may be a light transfer channel.

The light transfer channel 210 of the biochip 200 may be built in a body 201 of the biochip 200. The light transfer channel 210 may be a three dimensional structure having at least one hole penetrating the body 201 of the biochip 200. The body 201 of the biochip 200 may shield a light and the hole may penetrate a light. The body 210 of the biochip 200 may be a polymer or a plastic. The light transfer channel 210 of the biochip 200 may be manufactured when manufacturing the biochip 200. That is, the light transfer channel 210 of the biochip 200 may be simply and easily manufactured while the biochip 200 is manufactured to an injection molding or an extrusion molding of polymer or plastic.

The biochip identification apparatus 100 may include a display part 104 for displaying measurement information, operating buttons 105 and 106 for operation of the biochip identification apparatus 100 and a loading part 102 into which the biochip 200 is inserted. The biochip identification apparatus 100 may further include a light emitting part 114 irradiating a light into the biochip 200 and a light receiving part receiving a light which passed through the biochip 200.

The light emitting part 114 may irradiate a light into the light transfer channel 210 inserted into the loading part 102 of the biochip identification apparatus 100. The light emitting part 114 may include a light source which is one-wavelength light emitting diode (LED) or multi-wavelength laser diode. The light emitting part 114 may include three light sources emitting lights of different colors (e.g., red, green and blue) respectively. The light emitting part 114 in accordance with embodiments of the inventive concept may be constituted by combining three-color light emitting devices of red, green and blue. The three-color light emitting devices of the light emitting part 114 may be discontinuously controlled in a switching type. The light emitting part 114 may be included in the biochip identification apparatus 100.

The light receiving part 116 can receive a light pattern that passed through the light transfer channel 210 of the biochip 200 to convert it into an electrical signal. The light receiving part 116 may include one light receiving device. The light receiving device 116 may also include a plurality of light receiving devices. The light receiving device may include at least one selected from a photo diode, a photo triode, a CMOS image sensor (CIS) and a charge coupled device (CCD).

The biochip identification apparatus 100 may further include a compensation part 117 for checking stability (reproducibility) of a light that is emitted by the light emitting part 114. A part of light emitted by the light emitting part 114 may be directly transmitted to the compensation part 117 without passing through the light transfer channel 210 of the biochip 200. The compensation part 117 may check a state (e.g., reproducibility) of the light emitting part itself 114 through a light transmitted thereto. That is, by continuously monitoring a light from the light emitting part 114, the compensation part 117 checks deterioration of a light emitting device or a diode constituting the light emitting part 114 to obtain stability of identification of the biochip identification apparatus 100. If deterioration of the light emitting part 114 excesses a preset limit, the light emitting part 114 is replaced.

An operation of the biochip identification system is described. If a biological sample is put in the biochip 200, the sensing part 204 senses it. If the biochip 200 is built in the biochip identification apparatus 100, the type and manufacturing information of the biochip 200 is identified by the light receiving part 116. That is, if the biochip 200 is built in the biochip identification apparatus 100, the light receiving part 116 can identify a light pattern which passed through the light transfer channel 210 of the biochip 200. The light emitting part 114 and the light receiving part 116 may be disposed above and below so that a penetrated light is sensed. Information for identification of the biochip 200 may be a light pattern, a light strength or a color variation passing through the light transfer channel 210. Information of biological sample sensed in the sensing part 204 may be detected by a detection part of the biochip identification apparatus 100.

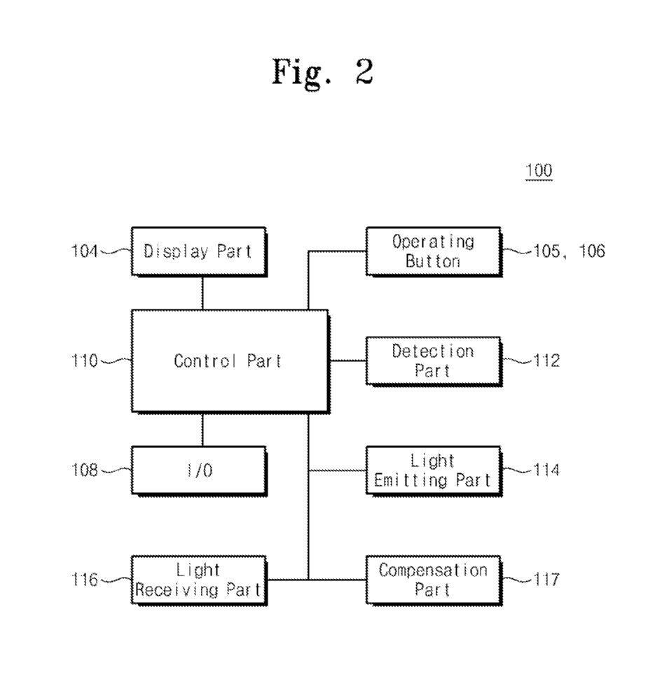

FIG. 2 is a block diagram for describing a biochip identification apparatus in accordance with some embodiments of the inventive concept. The constituent elements described with reference to FIGS. 1A and 1B use like reference numerals and the detailed description thereof is omitted.

Referring to FIG. 2, the biochip identification apparatus 100 in, accordance with some embodiments of the inventive concept may include a control part 110, a display part 104, operating buttons 105 and 106, an input/output 108, the detection part 112, the light emitting part 114, the light receiving part 116 and the compensation part 117.

The control part 110 controls the whole operation of the biochip identification apparatus 100. The control part 110 controls a wavelength of light and a switching of light emitted by the light emitting part 114, identifies the type and manufacturing information of the biochip 200 from a light pattern sensed by the light receiving part 116 and monitors a state of the light emitting part 114 from a light strength and a wavelength of light received to the compensation part 117. The biochip identification apparatus 100 receives an operation direction from a user through the operating buttons 105 and 106 and displays and/or transmits the operation direction to the outside through the display part 104 and/or the input/output 108.

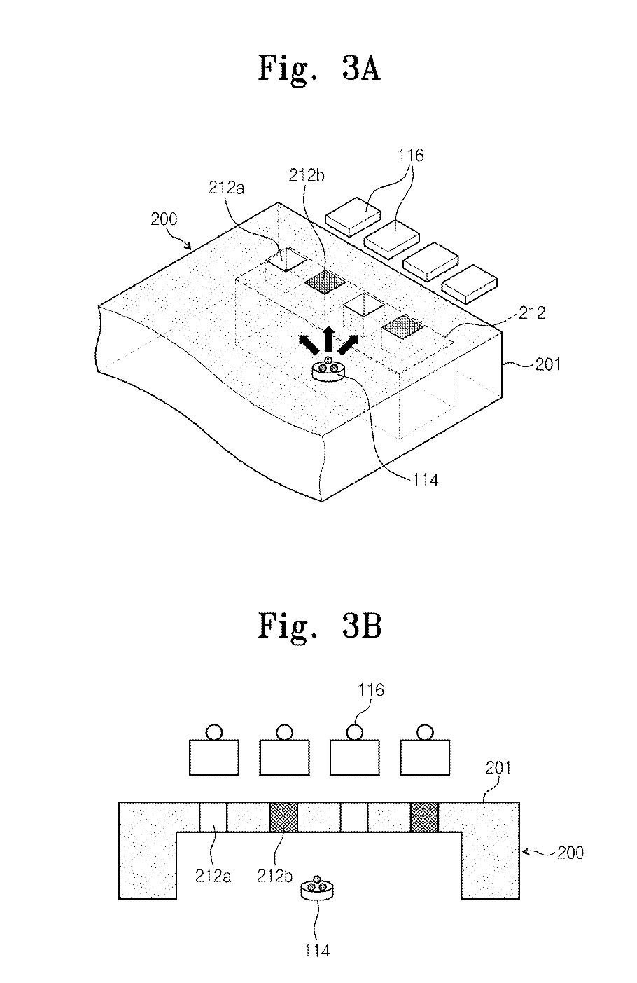

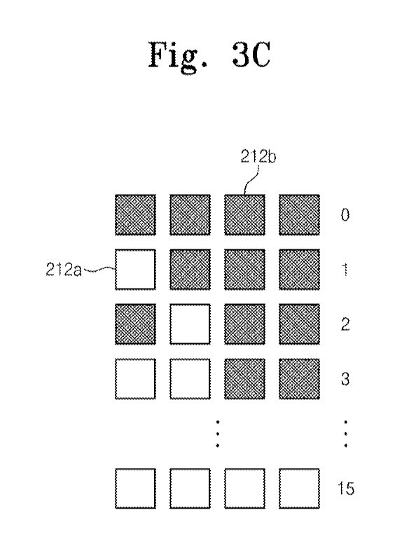

FIGS. 3A, 3B and 3C are a perspective view, a cross sectional view and a top plan view for describing a portion of biochip identification system in accordance with some embodiments of the inventive concept. The constituent elements described with reference to FIGS. 1A and 1B use like reference numerals and the detailed description thereof is omitted.

Referring to FIGS. 3A and 3B, the light transfer channel 210 may include a plurality of holes. The light receiving part 116 is a photo diode and may include a plurality of light receiving devices corresponding to an arrangement of the plurality of holes of the biochip 200. The number of the plurality of holes may be the same as the number of the plurality of light receiving devices. The plurality of light receiving devices may be disposed so as to correspond to locations of the holes. Selected holes among the plurality of holes may be filled with a light shielding material. That is, the plurality of holes may include light penetration holes 212a and light shielding holes 212b. Light receiving devices of the light receiving part 116 may receive or shield a light depending on locations of the light penetration holes 212a and the light shielding holes 212b. The light receiving part 116 may obtain a light pattern corresponding to a pattern formed by the light penetration holes 212a and the light shielding holes 212b. Also, when the light transfer channel 210 is manufactured together with the biochip 200, only the light penetration holes 212a may be formed without the light shielding holes 212b.

The light receiving part 116 may be a CMOS image sensor CIS or a charge coupled device CCD. The light receiving part 116 may obtain an image of light pattern from the light transfer channel 210.

The light penetration holes 212a may be two-dimensionally arranged. The plurality of light receiving devices may also be two-dimensionally arranged to receive lights which passed through the light penetration holes 212a. Lights penetrating the light penetration holes 212a of the biochip 200 may have an identification pattern. Thus, sensitivity identifying a light may be improved. A biochip may be easily built by two-dimensionally arranging the light receiving devices.

Referring to FIG. 3C, the holes of the biochip 200 may have, for example, an array of 4×15. The holes of the biochip 200 may also be arranged in a different type. That is, a variety of identification information about the biochip 200 may be generated depending on an arrangement of the light penetration holes 212a. Thus, the biochip 200 may have a variety of identification information and thereby the biochip identification system can identify various kinds of biochips.

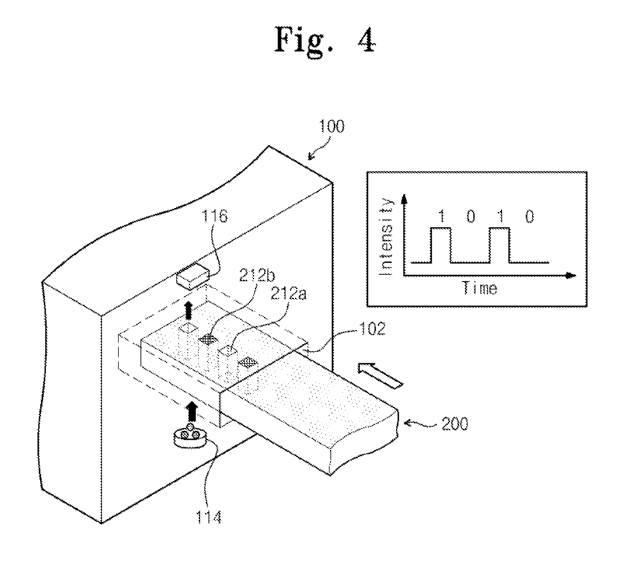

FIG. 4 is a perspective view for describing a portion of biochip identification system in accordance with some other embodiments of the inventive concept. The constituent elements described with reference to FIGS. 1A and 1B use like reference numerals and the detailed description thereof is omitted.

Referring to FIG. 4, while the biochip is inserted into the biochip identification apparatus 100, lights irradiated by the light emitting part 114 may be sequentially shielded or may penetrate the biochip 200 with time by the light penetration holes 212a, the light shielding holes 212b and/or the body of the biochip 200. The first hole is a light penetration hole and may function to tell the beginning of light pattern reception. By shielding and penetration of light, the light receiving part 116 may receive the temporal pattern of light. The temporal pattern of light received to the light receiving part 116 is converted into an electrical signal. The electrical signal may be a digital signal of “0” and “1”. In this case, the light receiving part 116 may include one light receiving device.

The light penetration holes 212a and the light shielding holes 212b of the biochip 200 may have a specific pattern array. The light penetration holes 212a and the light shielding holes 212b of the biochip 200 may be arrayed at periodic intervals. The light penetration holes 212a and the light shielding holes 212b of the biochip 200 may have a different pattern array depending on the biochip 200. The light pattern may have specific identification information according to the biochip 200. As illustrated in FIG. 4, the electric signal may be “1010”. The light pattern may be identified by the control part (110 of FIG. 2) of the biochip identification apparatus 100.

Accordingly, the biochip 200 may have a variety of identification information and thereby the biochip identification system can identify various kinds of biochips.

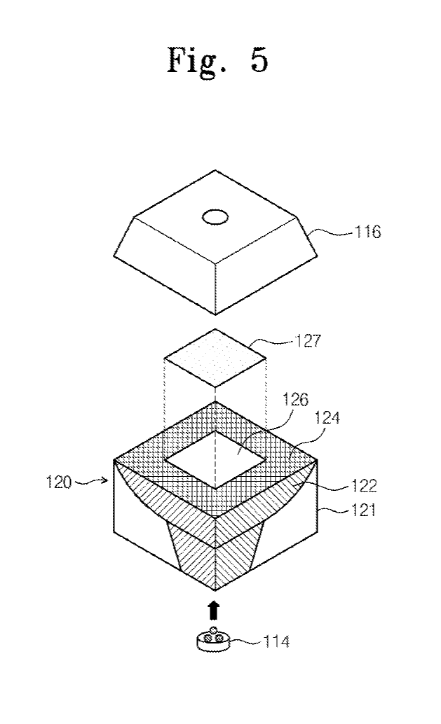

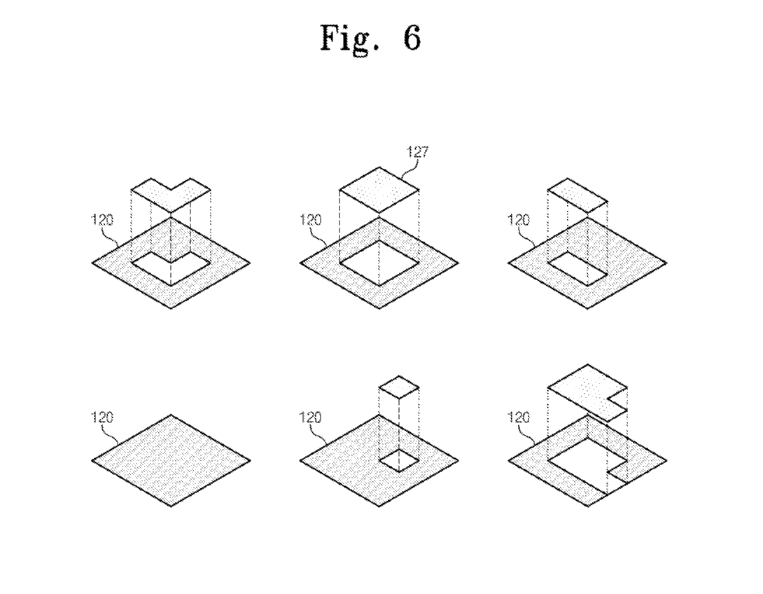

FIGS. 5 and 6 are a perspective view and a schematic view for describing a portion of biochip identification system in accordance with some other embodiments of the inventive concept. The constituent elements described with reference to FIGS. 1A and 1B use like reference numerals and the detailed description thereof is omitted.

Referring to FIG. 5, the biochip identification apparatus 100 may further include a pattern enlarging part 120 provided between the light receiving part 116 and the light transfer channel (210 of FIG. 1A) of the biochip 200. The pattern enlarging part 120 may enlarge a light which passed through the light transfer channel 210 of the biochip 200. In this case, the light transfer channel 210 may have one hole. The pattern enlarging part 120 may include a light penetration part 122 formed in a body 121 thereof. The body 121 of the pattern enlarging part 120 cannot penetrate a light and the light penetration part 122 can penetrate a light. The light penetration part 122 may have an empty space therein. Thus, a light which passed through the light transfer channel 210 of the biochip 200 penetrates the light penetration part 122, and then may come out of an end surface of the pattern enlarging part 120. Shielding patterns 124 are further provided on the end surface of the pattern enlarging part 120 to form an open window 126 transmitting a light.

The pattern enlarging part 120 enlarges a light that passed through the light transfer channel 210 of the biochip 200 to transmit the enlarged light pattern 127 to the light receiving part 116. Thus, a light that passed through the light transfer channel 210 of the biochip 200 may be more effectively sensed.

Referring to FIGS. 5 and 6, by applying various shielding patterns 124 to the end surface of the pattern enlarging part 120, a light received to the light receiving part 116 is diversely changed to provide various light patterns 127. Accordingly, the biochip 200 may have a variety of identification information and thereby the biochip identification system can identify various kinds of biochips.

In this case, the light receiving part 116 may be a CMOS image sensor CIS or a charge coupled device CCD. The light receiving part 116 may obtain a light pattern image.

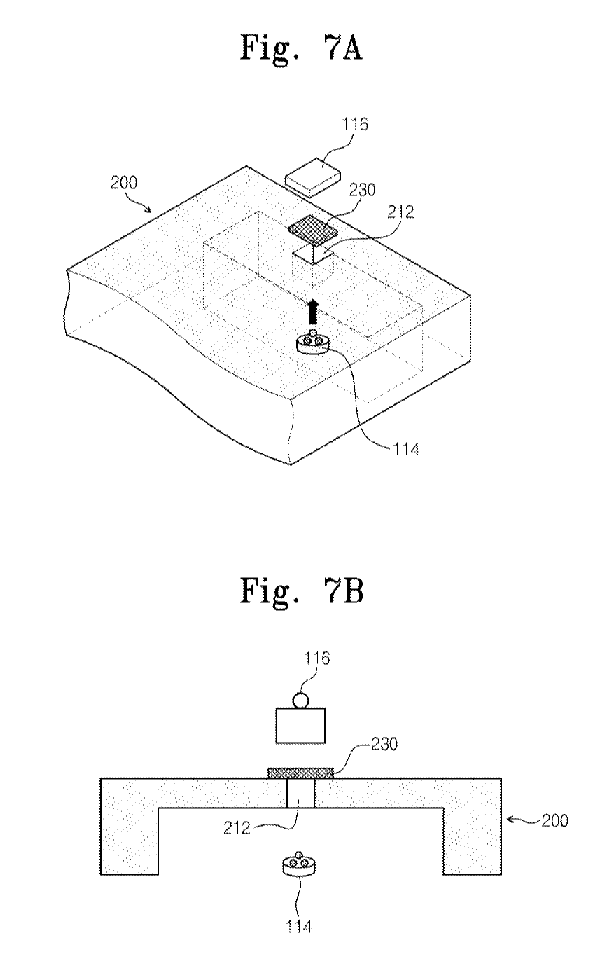

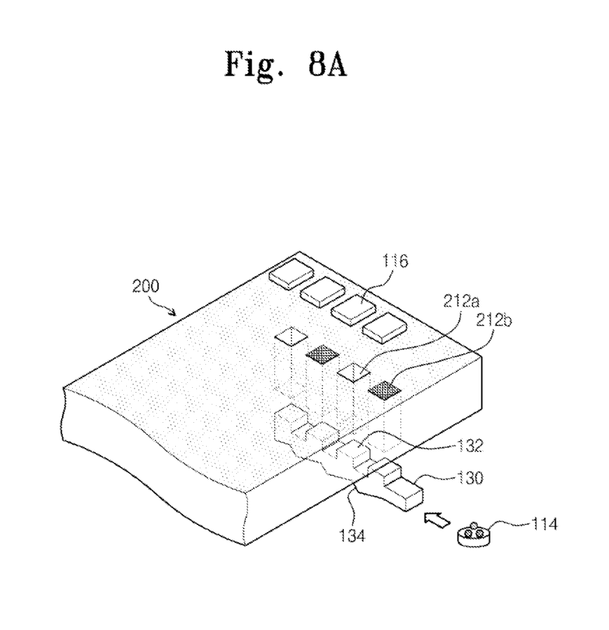

FIGS. 7A and 7B are a perspective view and a cross sectional view for describing a portion of biochip identification system in accordance with some other embodiments of the inventive concept. FIGS. 7A and 7B are a perspective view and a cross sectional view for describing a portion of biochip identification system in accordance with some other embodiments of the inventive concept.

Referring to FIGS. 7A and 7B, the biochip 200 may include a hole 212 penetrating a body thereof and a translucent film 230 covering the hole 212.

The light transfer channel 210 of the biochip 200 may include the hole 212 penetrating a body of the biochip 200 and the translucent film 230 covering the hole 212. That is, a light irradiated by the light emitting part 114 passed through the hole 212 and the translucent film 230 to be received to the light receiving part 116. The translucent film 230 may have various colors. The translucent film, 230 may have various transmittances. Strength or colors (e.g., chroma or brightness) of light which passed through the light transfer channel 210 of the biochip 200 may be different depending on a color and transmittance of the translucent film 230 and a wavelength of light irradiated by the light emitting part 114. The light receiving part 116 can identify the type and manufacturing information of the biochip by distinguishing a difference of light. Accordingly, the biochip 200 may have a variety of identification information and thereby the biochip identification system can identify various kinds of biochips.

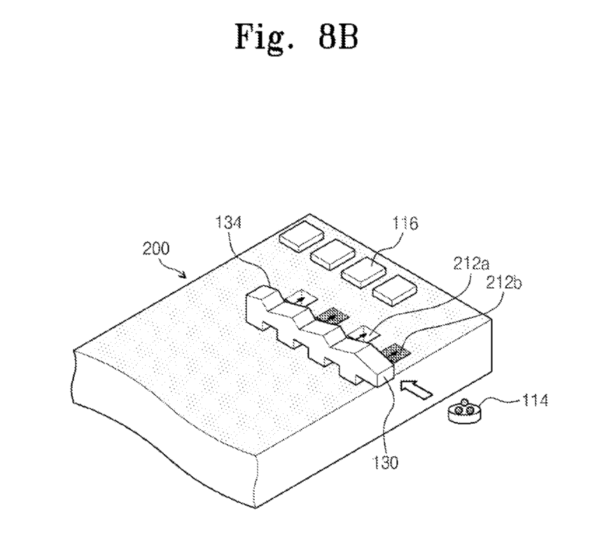

Referring to FIG. 8A, the light emitting part 114 may be disposed outside the biochip identification apparatus 100. It may be difficult that the light emitting part 114 and the light receiving part 116 are disposed above and below according to a structure of the biochip identification apparatus 100. In this case, the light emitting part 114 may be disposed outside the biochip identification apparatus 100. A light distribution transfer module 130 may be provided which is for transferring a light irradiated by the light emitting part 114 to the light transfer channel 210 of the biochip 200. The light distribution transfer module 130 may have a structure for transferring a light to each of the plurality of holes of the biochip 200. The light distribution transfer module 130 may have a shape corresponding to the plurality of holes of the biochip 200. For example, the light distribution transfer module 130 may have a protrusive part 132 and a reflection part 134 at the locations corresponding to the plurality of holes of the biochip 200. The reflection part 134 may be provided on a bottom surface of the light distribution transfer module 130 to transfer a light irradiated by the light emitting part 114 to the plurality of holes of the biochip 200 through the protrusive part 132. The reflection part 134 may have the slope inclined at 45° toward the protrusive part 132. The slope may be coated with a reflection plane (e.g., silver (Ag)) to increase a reflection efficiency. The light distribution transfer module 130 may be formed in a single body with the biochip identification apparatus 100. A body of the biochip identification apparatus 100 is translucent and the light distribution transfer module 130 may include a material that can permit penetration of a light.

A light irradiated by the light emitting part 114 is distributed by the light distribution transfer module 130 to be transferred to the plurality of holes of the biochip 200. The transferred light is shielded by the plurality of holes of the biochip 200 and/or penetrates the plurality of holes of the biochip 200 and the light which penetrated the holes may be received to the light receiving devices of the light receiving part 116.

Referring to FIG. 8B, the light distribution transfer module 130 may be disposed between the biochip 200 and the light receiving part 116. The light distribution transfer module 130 may be disposed to be adjacent to the light transfer channel 210 to reflect a light irradiated by the light emitting part 114 to the plurality of holes. That is, a light reflected by the reflection part 134 is provided to the plurality of holes and is reflected again by the light shielding holes 212b to be transferred to the light receiving part 116. Top surfaces of the light shielding holes 212b may be coated with reflection plane. The light shielding holes 212b can reflect a light reflected by the reflection part 134 again but the light penetration holes 212a cannot reflect a light reflected by the reflection part 134 again. In the drawing, the light distribution transfer module 130 is spaced apart from the plurality of holes but it may be disposed to overlap the plurality of holes.

The embodiments of aforementioned biochip identification system may be combined with each other to be changed to various types.

According to some embodiments of the inventive concept, while manufacturing a biochip, identification information of biochip can be manufactured and thereby cost for manufacturing identification information of the biochip may be reduced. The biochip in accordance with some embodiments of the, inventive concept has a simple structure that does not need to add a separate structure to a general portable identification apparatus and may obtain measurement information about the biochip rapidly and accurately.

Further, there is no need to input information about the biochip separately before loading the biochip in the biochip identification apparatus and an error that can occur when user inputs information may be prevented. Separate expensive equipment for identifying the biochip like a barcode is not needed and identification and measurement information about the biochip may be obtained rapidly and accurately. The biochip identification apparatus in accordance with some embodiments of the inventive concept may be widely used in an emergency room, a private hospital, an ambulance and home by professionals and ordinary persons.

The above-disclosed subject matter is to be considered illustrative, and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A biochip identification apparatus comprising:
a light emitting part irradiating a light to a light transfer channel having at least one hole penetrating a body of biochip;
a light receiving part receiving a light pattern formed after the light passed through the light transfer channel and converting it into an electrical signal; and
an loading part into which the biochip is inserted,
wherein the biochip is identified by a shape of the light pattern.

2. The biochip identification apparatus of claim 1, wherein the light emitting part is provided inside the biochip identification apparatus and the biochip is inserted between the light emitting part and the light receiving part.

3. The biochip identification apparatus of claim 1, wherein the number of the hole is two or more and the light emitting part is provided outside the biochip identification apparatus, further comprising a light distribution transfer module for transferring the light irradiated by the light emitting part to the light transfer channel, and wherein the light distribution transfer module has a shape corresponding to an arrangement of the plurality of holes.

4. The biochip identification apparatus of claim 3, wherein the light distribution transfer module is provided under the loading part and has an inclined reflection plane toward the plurality of holes under the light distribution transfer module so as to correspond to the plurality of holes.

5. The biochip identification apparatus of claim 3, the light distribution transfer module is provided between the loading part and the light receiving part, has an inclined reflection plane toward the plurality of holes on the light distribution transfer module so as to correspond to the plurality of holes and is disposed so that a part of the light distribution transfer module overlaps the plurality of holes.

6. The biochip identification apparatus of claim 1, wherein the number of the holes is two or more and the plurality of the holes is two dimensionally arrayed

7. The biochip identification apparatus of claim 1, wherein the number of the holes is two or more and the light receiving part comprises a plurality of light receiving devices arranged so as to correspond to the plurality of holes.

8. The biochip identification apparatus of claim 1, wherein the number of the holes is two or more and the light receiving part receives the light pattern formed after the light irradiated by the light emitting part passed through the plurality of holes while the biochip is inserted into the loading part, and then converts it into an electrical signal.

9. The biochip identification apparatus of claim 1, further comprising a pattern enlarging part being provided between the light receiving part and the light transfer channel and enlarging the light pattern.

10. The biochip identification apparatus of claim 9, wherein a light shielding pattern is formed on an end surface of the pattern enlarging part and the light pattern is transferred to the light receiving part through a window exposed by the light shielding pattern.

11. The biochip identification apparatus of claim 1, further comprising a compensation part checking a state of the light emitting part by directly receiving a light that did not pass through the light transfer channel.

12. A biochip identification apparatus comprising:
a light emitting part irradiating a light to a light transfer channel including a hole penetrating a body of biochip and a translucent film covering the hole;
a light receiving part receiving a light that passed through the light transfer channel and then converting it into an electrical signal; and
a loading part to which the biochip is inserted,
wherein the biochip is identified by recognizing a difference of strength or color of the light by the translucent film.

13. A biochip comprising:
a body;
a biological sample inlet disposed on the body;
a sensing part sensing the biological sample transferred from the biological sample inlet; and
a light transfer channel having at least one hole penetrating the body and through which a light passes.

14. The biochip of claim 13, further comprising a translucent film disposed on the hole.

15. The biochip of claim 13, wherein the number of the holes is two or more and the holes are two dimensionally arrayed.

16. A method of identifying a biochip comprising:
loading a biochip including a body and a light transfer channel having at least one hole penetrating the body by inserting them into a biochip identification apparatus;
irradiating a light to the light transfer channel;
receiving a light that passed through the light transfer channel and converting it into an electrical signal; and
identifying the biochip by the light.

17. The method of identifying a biochip of claim 16, wherein the biochip is identified by a shape of pattern of light that passed through the light transfer channel.

18. The method of identifying a biochip of claim 17, wherein the number of the holes is two or more, the holes are two dimensionally arrayed and a light that passed through the light transfer channel has a two dimensional pattern.

19. The method of identifying a biochip of claim 16, wherein the number of the holes is two or more and while the biochip is inserted into the biochip identification apparatus, the biochip is identified by a temporal pattern of light passing through the plurality of holes.

20. The method of identifying a biochip of claim 16, wherein the biochip is identified by strength or color of light that passed the hole.
